(19) United States
(12) Patent Application Publication
(10) Pub. No.: US 2015/0224902 A1
(43) Pub. Date: Aug. 13, 2015

(54) ATTACHMENT STRUCTURE FOR CONNECTING MEMBER FOR SEAT AND ATTACHABLE MEMBER, AND SEAT STRUCTURE

(71) Applicant: TS TECH CO., LTD., Asaka-shi, Saitama (JP)

(72) Inventor: Masaya Furuta, Tochigi (JP)

(73) Assignee: TS TECH CO., LTD., Asaka-shi, Saitama (JP)

(21) Appl. No.: 14/430,377

(22) PCT Filed: Sep. 11, 2013
(86) PCT No.: PCT/JP2013/074461

§ 371 Date: Mar. 23, 2015

(30) Foreign Application Priority Data
Sep. 24, 2012 (JP) 2012-209971

(51) Int. Cl. B60N 2/68

(52) U.S. Cl. CPC B60N 2/682

(57) ABSTRACT

An attachment structure for a connecting member for seat and an attachment member includes a connecting member for seat in a form of a pipe and an attachment member provided with an engaging part to engage with an end portion of the connecting member for seat. The engaging part includes a plurality of contact portions circumferentially arrayed with a predetermined interval to make contact with an inner circumferential surface of the connecting member for seat, and a plurality of non-contact portions, each provided between the contact portions, making no contact with the inner circumferential surface of the connecting member for seat. An adhesive is applied to the non-contact portion when the engaging part of the attachment member engages with the end portion of the connecting member for seat.

### TECHNICAL FIELD

The present invention relates to an attachment structure for a connecting member for seat and an attachment member, and a seat structure.

### BACKGROUND ART

In a conventional seat structure of vehicles, a connecting member in the form of a pipe extends between a pair of cushion frames. On an end of the connecting member, for example, a pin member for adjusting the distance between the pair of cushion frames or an attachment member, such as shaft member for pivotally supporting a link member, is inserted and fixed by welding (for example, see Patent Literature 1).

### CITATION LIST

### Patent Literature

Patent Literature 1: Japanese Unexamined Patent Application Publication No. 2012-136088 A

### SUMMARY OF INVENTION

### Technical Problem

Recently, a seat structure using a resin-made cushion frame has been developed. However, for a resin-made connecting member, welding cannot be actually used to fix an attachment member because the connecting member melts by welding.

The object of the present invention is to tightly join an attachment member to a resin-made connecting member.

### Solution to Problem

To solve the problem, an attachment structure for a connecting member for seat and an attachment member according to claim 1 includes, a connecting member for seat in a form of a pipe; and an attachment member provided with an engaging part to engage with an end portion of the connecting member for seat, wherein the engaging part includes a plurality of contact portions circumferentially arrayed with a predetermined interval to make contact with an inner circumferential surface of the connecting member for seat, and a plurality of non-contact portions, each provided between the contact portions, making no contact with the inner circumferential surface of the connecting member for seat, and an adhesive is applied to the non-contact portion when the engaging part of the attachment member engages with the end portion of the connecting member for seat.

The invention of claim 2 is the attachment structure for a connecting member for seat and an attachment member according to claim 1, wherein at least the three contact portions are provided, and a center of the connecting member for seat is positioned inside a polygonal area formed by connecting the at least three contact portions.

The invention of claim 3 is the attachment structure for a connecting member for seat and an attachment member according to claim 1 or 2, wherein a notch is formed in the end portion of the connecting member for seat, and a protrusion which engages with the notch is provided on the engaging part of the attachment member.

The invention of claim 4 is the attachment structure for a connecting member for seat and an attachment member according to claim 3, wherein the protrusion is formed on the non-contact portion.

The invention of claim 5 is the attachment structure for a connecting member for seat and an attachment member according to claim 3 or 4, wherein an axial length of the contact portion is longer than an axial length of the protrusion.

The invention of claim 6 is the attachment structure for a connecting member for seat and an attachment member according to any one of claims 3 to 5, wherein a plurality of the notches are provided in the end portion of the connecting member for seat, and a plurality of the protrusions, each of which configured to engage with each of the plurality of notches, are provided.

The invention of claim 7 is the attachment structure for a connecting member for seat and an attachment member according to any one of claims 1 to 6, wherein the contact portion is tapered to have a height gradually decreasing toward a distal end.

The invention of claim 8 is a seat structure including a connecting member for seat in a form of a pipe extending between right-and-left cushion frames; and an attachment member, wherein the connecting member for seat is formed in a pipe, the attachment member includes an engaging part which engages with an end portion of the connecting member for seat, the engaging part includes a plurality of contact portions circumferentially arrayed with a predetermined interval to make contact with an inner circumferential surface of the connecting member for seat, and a plurality of non-contact portions, each provided between the contact portions, making no contact with the inner circumferential surface of the connecting member for seat, and an adhesive is applied to the non-contact portion when the engaging part of the attachment member engages with the end portion of the connecting member for seat.

### Advantageous Effects of Invention

According to the invention of claim 1, when an engaging part of an attachment member engages with an end portion of a connecting member for seat, an adhesive is applied to the non-contact portion so that a large amount of adhesive can be applied compared to a structure in which the entire periphery of the engaging part makes contact with the inner circumferential surface of the connecting member for seat. Since the adhesive strength increases as the amount of adhesive increases, the attachment member can tightly be joined to the resin-made connecting member for seat.

Moreover, with a plurality of contact portions making contact with the inner circumferential surface of the connecting member for seat, the attachment member is correctly positioned with respect to the connecting member for seat. So that, the gap between the non-contact portion and the connecting member for seat is stabilized, and a constant amount of adhesive can be applied to the non-contact portion 411, thereby providing steady strength of joining the attachment member.

According to the invention of claim 2, the center of the connecting member for seat is positioned inside a polygonal area formed by connecting at least three contact portions, so that the attachment member can be positioned in the connecting member for seat without eccentricity.

According to the invention of claim 3, a protrusion of the attachment member engages with a notch of the connecting member for seat to restrict rotational motion between the connecting member for seat and the attachment member when the connecting member for seat and the attachment member almost rotate relatively. Hence, the relative rotational motion between the connecting member for seat and the attachment member can be restricted.

According to the invention of claim 4, the protrusion is formed on the non-contact portion. Thus the protrusion can be separated from the contact portion. With the protrusion and the contact portion provided to be separated from each other, high rigidity of the attachment member can be provided compared to a structure with the protrusion and the contact portion adjoiningly or integrally provided.

According to the invention of claim 5, the axial length of the contact portion is longer than that of the protrusion to provide a large area that contacts the connecting member for seat, thereby stably disposing the attachment member in the connecting member for seat.

According to the invention of claim 6, each of a plurality of protrusions engages with each of a plurality of notches, thereby dispersing a load applied to each protrusion. Thus, the protrusion does not need to be made large in size, and the attachment member can be downsized.

According to the invention of claim 7, the contact portion is tapered, having a height gradually decreasing toward the distal end, which allows the attachment member to be inserted smoothly in the end portion of the connecting member for seat without the attachment member sticking at the end portion.

According to the invention of claim 8, the effect similar to that according to claim 1 can be provided. So that the rigidity of the joining portion of the connecting member for seat can be increased, thereby the rigidity of the seat itself being increased.

### BRIEF DESCRIPTION OF DRAWINGS

FIG. 1 is a side view illustrating a schematic configuration of a seat structure according to the embodiment.

FIG. 2 is a sectional view illustrating a schematic configuration of a coupling structure for joining a connecting member for seat and an attachment member according to the embodiment.

FIG. 3 is a perspective view illustrating a schematic configuration of a coupling structure for joining the connecting member for seat and an attachment member in FIG. 2.

FIG. 4 is a perspective view illustrating a schematic configuration of a shaft member according to the embodiment.

FIG. 5 is a front view of the shaft member in FIG. 4.

FIG. 6 is a sectional view taken along the line V-V in FIG. 5.

### DESCRIPTION OF EMBODIMENTS

An embodiment of the present invention will be described below referring to the drawings. Though the embodiment preferably includes various technical limitations, the scope of the present invention is not limited by the embodiment or illustrative drawings.

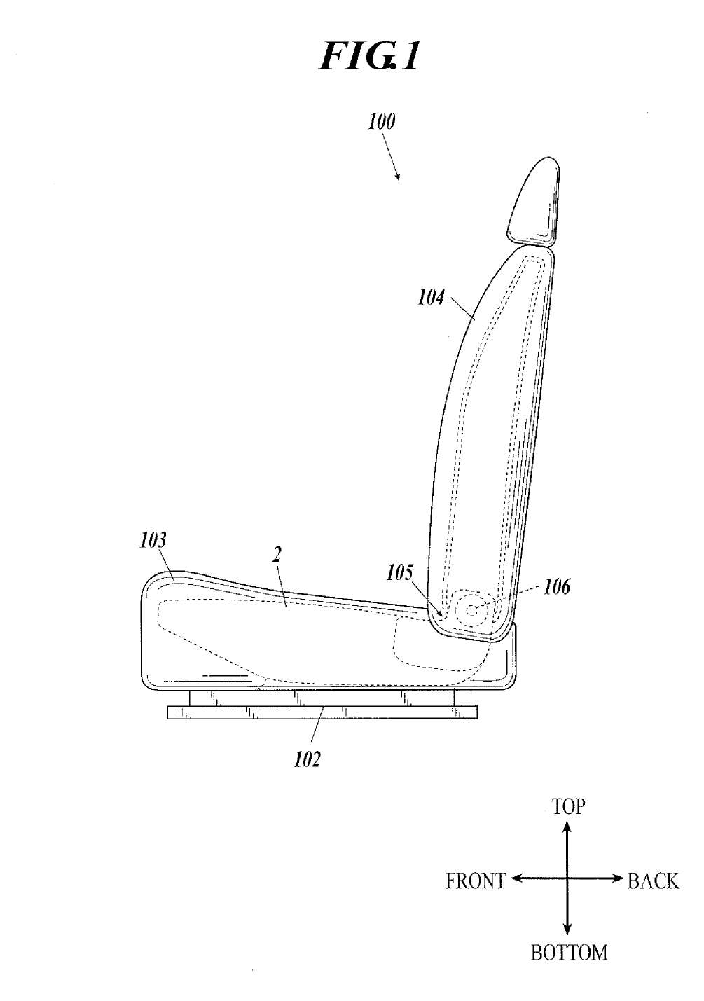

FIG. 1 is a side view illustrating a schematic configuration of a seat structure according to the embodiment. The seat structure according to the embodiment is used for a seat of vehicles. As illustrated in FIG. 1, the seat structure 100 includes a slide rail 102, a bottom seat 103, a back rest 104, a reclining mechanism 105, and other components. The reclining mechanism 105 connects the bottom end of the back rest 104 and the rear end of the bottom seat 103, and the back rest 104 stands upright at the rear end of the bottom seat 103. The reclining mechanism 105 allows the back rest 104 to swing forward and backward with respect to the bottom seat 103. The reclining mechanism 105 can lock the back rest 104 to the bottom seat 103, thereby restricting the swinging of the back rest 104, and can release the lock to urge the back rest 4 to swing forward.

The bottom seat 103 includes a pair of right-and-left frames 2 and a connecting member 6 in the form of a pipe to connect the pair of right-and-left frames 2. The frames 2 and the connecting member 6 are connected via pin members 3 and shaft members 4, which will be described later.

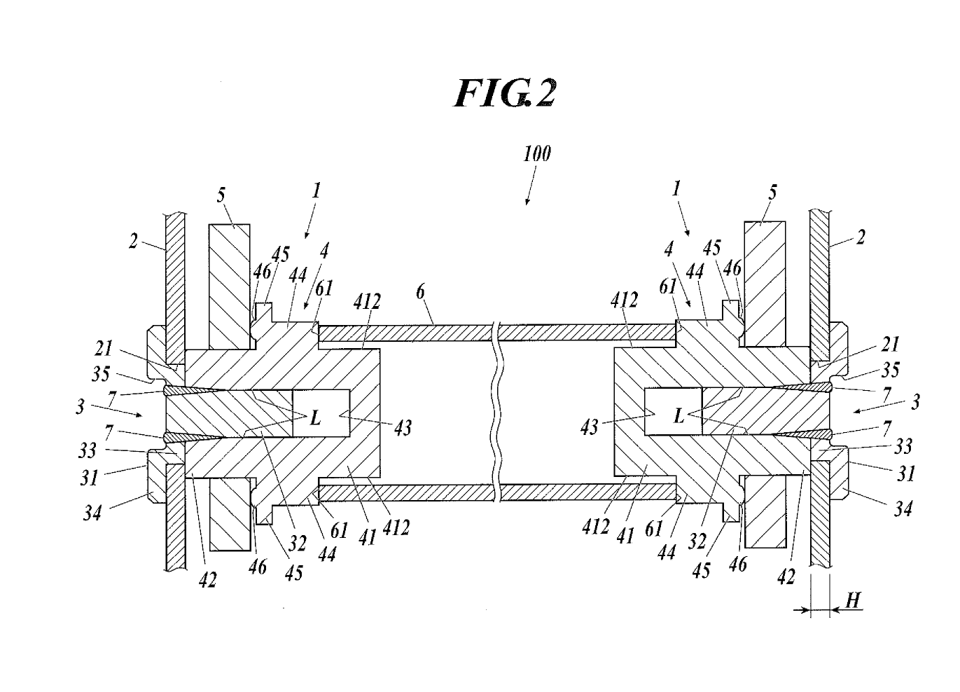

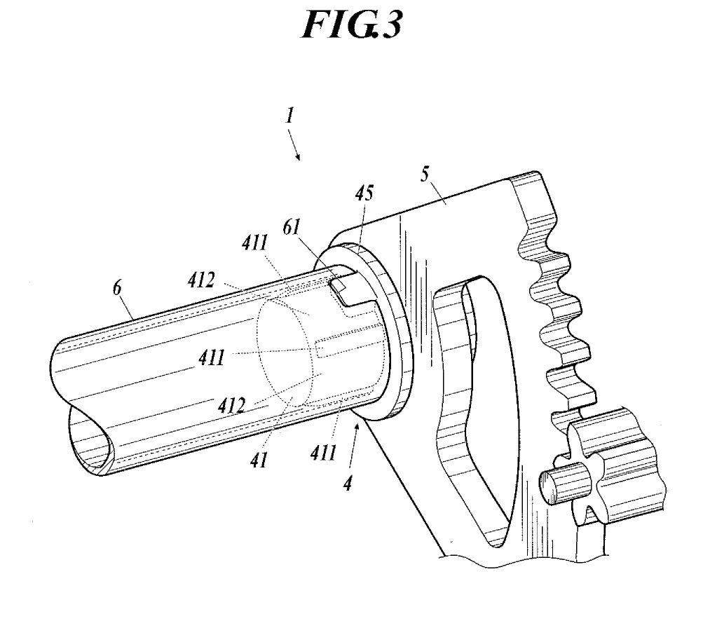

FIG. 2 is a sectional view illustrating a schematic configuration of a coupling structure for joining a connecting member for seat and an attachment member according to the embodiment. FIG. 3 is a perspective view illustrating a schematic configuration of the coupling structure for joining the connecting member for seat and an attachment member. As illustrated in FIGS. 2 and 3, the coupling structure 1 for joining a connecting member for seat and an attachment member includes the frames 2, the pin members 3 that each engages with the frames 2, the shaft members 4, that is, attachment (attachable) members each coaxially attached to the pin members 3, a link members 5 each pivotally supported by the shaft members 4 so as to be disposed approximately parallel to the frames 2, and the connecting member 6 which is in the form of a pipe and serves as a connecting member for seat.

Each of the frames 2 is formed of resin and provided as, for example, a cushion frame of a seat structure 100. The frame 2 has a through hole 21 with which the pin member 3 engages.

Each of the pin members 3 includes a pin head 31 and a column-shaped projecting portion 32 which axially projects from the pin head 31. The pin head 31 is provided with an engaging part 33 which engages with the through hole 21 of the frame 2 and a stepped portion 34 which seats on the frame 2. The stepped portion 34 has a step-height H which is set substantially identical to the thickness of the frame 2. A recessed portion 35 having an inner diameter larger than the outer diameter of the projecting portion 32 is formed in the pin head 31 on the side opposite to the projecting portion 32.

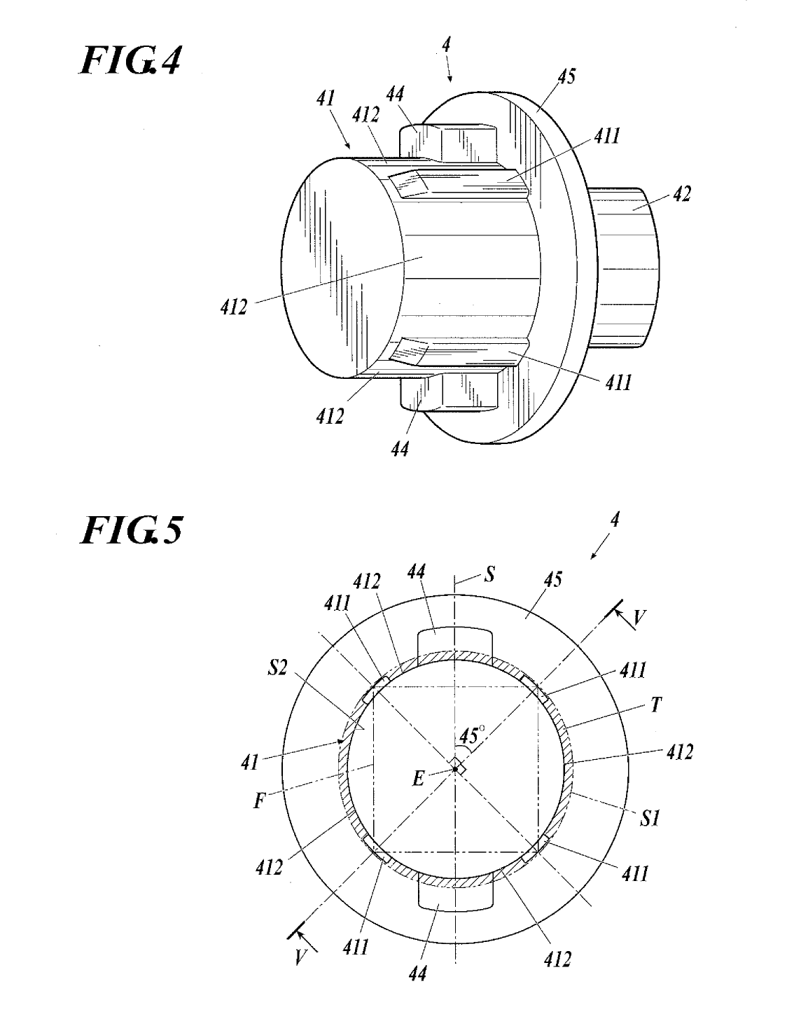

Each of the shaft members 4 is attached to the each end portion of the connecting member 6 extending between the pair of frames 2. FIG. 4 is a perspective view illustrating a schematic configuration of the shaft member 4, and FIG. 5 is a front view of the shaft member 4. As illustrated in FIGS. 2 to 5, the shaft member 4 includes an engaging part 41 which engages with the end portion of the connecting member 6, a shaft 42 which pivotally supports the link member 5, and a recessed portion 43 with which the projecting portion 32 of the pin member 3 engages.

The engaging part 41 includes a plurality of contact portions 411 circumferentially arrayed with a predetermined interval to make contact with the inner circumferential surface of the connecting member 6 and a non-contact portions 412 each of which is provided between the plurality of contact portions 411 and makes no contact with the inner circumferential surface of the connecting member 6. In the embodiment, four contact portions 411 are evenly disposed as illustrated by example. The four contact portions 411 are evenly disposed by 90 degrees with each radial direction inclined from the position which is shifted 45 degree to the vertical line. The outer circumferential surfaces of the four contact portions 411 are formed along on a circumferential surface S1 that is substantially identical to the inner circumferential surface of the connecting member 6. The center E of the connecting member 6 is positioned in a squared area F formed by connecting the center of contact portions 411.

The outer circumferential surfaces of the non-contact portions 412 are formed along on a circumferential surface S2, which is concentric with and has smaller diameter than the circumferential surface S1. Thus, the step between the non-contact portion 412 and the contact portion 411 produces a gap, when the engaging part 41 engages with the connecting member 6. An adhesive is applied to the outer circumferential surface of the engaging part 41 before engaging. The adhesive applied to the outer circumferential surface of the contact portion 411 is mostly removed by the inner circumferential surface of the connecting member 6 so that a very little portion remains. The most of the adhesive moves to the non-contact portion 412 to fill the non-contact portion 412 (hatched portion T in FIG. 5 represents the adhesive).

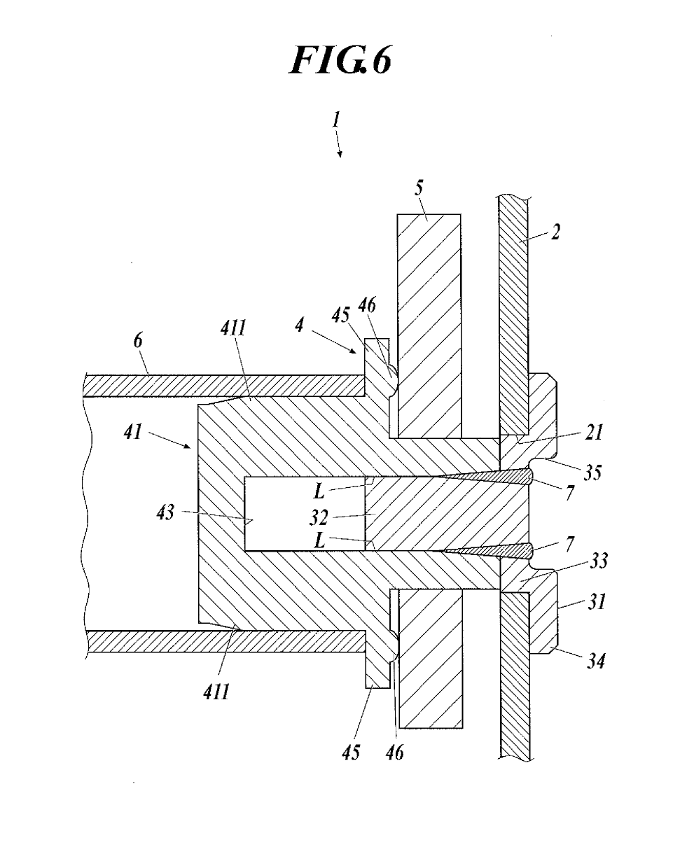

FIG. 6 is a sectional view taken along the line V-V in FIG. 5. As illustrated in FIG. 6, the contact portion 411 extends as far as to the vicinity of the distal end of the engaging part 41. The contact portion 411 is tapered, having a height gradually decreasing toward the distal end.

First protrusions 44 are respectively provided between the two contact portions 411 on the upper part and between the two contact portions 411 on the lower part of the engaging part 41. The first protrusion 44 on the upper part engages with a notch 61 provided on the top and the first protrusion 44 on the lower part engages with a notch 61 on the bottom of the end portion of the connecting member 6 to restrict circumferential rotation of the shaft member 4. The first protrusion 44 is shorter, in the axial direction, than the contact portion 411.

A rib 45 is provided on the proximal end of the engaging part 41 to extend in the circumferential direction. The rib 45 engages with the end portion of the connecting member 6 to correctly position the shaft member 4. The first protrusion 44 and the contact portion 411 are respectively formed so as to extend to the rib 45. Second protrusions 46, each of which has a cross section with an arc-shaped contour, are protrudingly provided on the surface, opposite to the connecting member 6, of the rib 45. The second protrusion 46 is provide on the extended line in the axial direction of the connecting member 6. The second protrusion 46 also is provided on the extended line in the axial direction of the contact portion 411. That is, the second protrusion 46 and the contact portion 411 are respectively provided in the same plane passing in the axial direction of the connecting member 6.

The column-shaped shaft 42 is formed to be coaxial with the engaging part 41. The outer diameter of the shaft 42 is smaller than the outer diameter of the connecting member 6 and larger than the inner diameter of the through hole 21 of the frame 2. The end face of the shaft 42 can thus make contact with the engaging part 33 of the pin member 3 and the frame 2.

The recessed portion 43 is recessed from an end face of the shaft member 4 and extends along the axis of the engaging part 41 and the shaft 42 to form a cylindrical hollow. The recessed portion 43 passes through the link member 5 and extends further to the inside of the connecting member 6 through the end portion thereof. When the pin member 3 engages with the recessed portion 43, the projecting portion 32 is positioned so as to penetrate the link member 5 and is disposed inside the end portion of the connecting member 6. The boundary L, between the recessed portion 43 and the projecting portion 32 of the pin member 3, is laser welded and a welding mark 7 is formed. Since a laser beam for welding is emitted from the outside of the frame 2, the welding mark 7 is formed in a wedge-shape in cross-section, which becomes thicker toward the outside of the frame 2 and thinner toward the inside of the frame 2. The welding mark 7 extends as far as to reach the link member 5. Thus, the welding mark 7, the stepped portion 34 and the frame 2 exist on the same vertical plane.

The link member 5 constitutes a part of, for example, the reclining mechanism 5 of the seat structure 100 or a seat position adjusting mechanism. The link member 5 is pivotally supported by the shaft 42 of the shaft member 4 so as to pivot about the shaft 42. A face of the link member 5 is in contact with the second protrusion 46 of the shaft member 4. The second protrusion 46 creates a space between the link member 5 and the rib 45. Filling the adhesive in the space ensures the amount of adhesive for attaching the link member 5 to the shaft member 5, thereby increasing the strength of joining the link member 5 and the shaft member 5.

According to the embodiment as described above, when the engaging part 41 of the shaft member 4 engages with the end portion of the connecting member 6, a large amount of adhesive can be applied, with the adhesive applied to the non-contact portion 412, compared to the structure where the entire periphery of the engaging part 41 makes contact with the inner circumferential surface of the connecting member 6. Since the adhesive strength increases as the amount of adhesive increases, the structure can tightly join the shaft member 4 even to a resin-made connecting member 6.

Furthermore, as a plurality of contact portions 411 makes contact with the inner circumferential surface of the connecting member 6, the shaft member 4 is correctly positioned in the connecting member 6. So that, the gap between the non-contact portion 411 and the connecting member 6 is set stably, and a constant amount of adhesive can be applied to a plurality of non-contact portions. Thus, the strength for joining the shaft member 4 can steadily be provided.

If the shaft member 4 can tightly be joined to the connecting member 6, the rigidity of the joining portion of the connecting member 6 can be increased, thereby increasing the rigidity of the seat itself.

Since the center of the connecting member 6 is positioned inside the squared area formed by connecting four contact portions 411, the shaft member 4 can be positioned in the connecting member 6 without eccentricity.

Further, the first protrusion 44 of the shaft member 4 engages with the notch 61 of the connecting member 6 to restrict the initial rotational motion between the connecting member 6 and the shaft member 4 when the connecting member 6 and the shaft member 4 almost rotate relatively. Thus, the relative rotational motion between the connecting member 6 and the shaft member 4 can be restricted.

The axial length of the contact portion 411 is longer than that of the first protrusion 44 to provide a large area that contacts the connecting member 6, thereby stably disposing the shaft member 4 in the connecting member 6.

Furthermore, the contact portion 411 is tapered, having a height gradually decreasing toward the distal end, which allows the shaft member 4 to be inserted smoothly in the end portion of the connecting member 6 without the contact portion 411 sticking at the end portion.

The first protrusion 44, formed on the non-contact portion 412, can be provided so as to be separated from the contact portion 411. With the first protrusion 44 and the contact portion 411 provided to be separated from each other, high rigidity of the shaft member 4 can be obtained compared to a structure with the first protrusion 44 and the contact portion 411 adjoiningly or integrally provided.

Moreover, each of the plurality of first protrusions 44 engages with each of the plurality of notches 61, thereby dispersing a load to reduce the load applied to each of the first protrusions 44. Thus, the first protrusion 44 does not need to be made large in size, and the shaft member 4 can be downsized.

If the notch 61 and the first protrusion 44 are provided in the upper portion and the lower portion as described above, the engagement of the notches 61 with the first protrusions 44 can easily be checked.

The embodiment according to the present invention is not limited to the aforementioned embodiment, and modifications can optionally be made as required without departing from the spirit and scope of the present invention. Hereinafter, the same component as the aforementioned embodiment is appended with the same reference sign and the description thereof is omitted.

For example, although four contact portions 411 are provided in the aforementioned embodiment, the number of contact portions 411 may be three or more. In any case, it is preferable that the center of the connecting member 6 is located inside a polygonal area formed by connecting at least three contact portions 411. In this manner, the shaft member 4 can be positioned in the connecting member 6 without eccentricity.

In the aforementioned embodiment, though the shaft member 4, which pivotally supports the link member 5, is provided as the attachment member, other form of attachment members may be a pin member that engages with the end portion of the connecting member 6 to adjust the distance between a pair of cushion frames.

In the aforementioned embodiment, though the outer circumferential surface of the non-contact portion 412 is formed to be concentric with the outer circumferential surface of the contact portion 411, the non-contact portion 412 may be formed in any shape that avoids contact with the inner circumferential surface of the connecting member 6.

In the aforementioned embodiment, the coupling structure for joining a connecting member for seat and an attachment member is described. It goes without saying that this structure can be used for a coupling structure for joining other connecting members and an attachment member.

### INDUSTRIAL APPLICABILITY

The coupling structure for joining a connecting member for seat and an attachment member, and the seat structure can be used, for example, for a resin-made cushion frame mounted on vehicles.

### REFERENCE SIGNS LIST

1 coupling structure for joining a frame and a shaft
2 frame (cushion frame)
3 pin member
4 shaft member (attachment member)
5 link member
6 connecting member (connecting member for seat)
7 welding mark
21 through hole
31 pin head
32 projecting portion
33 engaging part
34 stepped portion
35 recessed portion
41 engaging part
42 shaft
43 recessed portion
44 first protrusion (protrusion)
45 rib
46 second protrusion
61 notch
100 seat structure
102 slide rail
103 bottom seat
104 back rest
105 reclining mechanism
411 contact portion
412 non-contact portion
L boundary
T hatched portion (adhesive)

1. An attachment structure for a connecting member for seat and an attachment member comprising:
a connecting member for seat in a form of a pipe; and
an attachment member provided with an engaging part to engage with an end portion of the connecting member for seat, wherein
the engaging part includes a plurality of contact portions circumferentially arrayed with a predetermined interval to make contact with an inner circumferential surface of the connecting member for seat, and a plurality of non-contact portions, each provided between the contact portions, making no contact with the inner circumferential surface of the connecting member for seat, and
an adhesive is applied to the non-contact portion when the engaging part of the attachment member engages with the end portion of the connecting member for seat.

2. The attachment structure for a connecting member for seat and an attachment member according to claim 1, wherein
at least the three contact portions are provided, and
a center of the connecting member for seat is positioned inside a polygonal area formed by connecting the at least three contact portions.

3. The attachment structure for a connecting member for seat and an attachment member according to claim 1, wherein
a notch is formed in the end portion of the connecting member for seat,
a protrusion which engages with the notch is provided on the engaging part of the attachment member, and
the protrusion is disposed between the two contact portions among the at least three contact portions.

4. The attachment structure for a connecting member for seat and an attachment member according to claim 3, wherein the protrusion is formed on the non-contact portion.

5. The attachment structure for a connecting member for seat and an attachment member according to claim 3, wherein an axial length of the contact portion is longer than an axial length of the protrusion.

6. The attachment structure for a connecting member for seat and an attachment member according to claim 3, wherein
a plurality of the notches are provided in the end portion of the connecting member for seat, and
a plurality of the protrusions, each of which configured to engage with each of the plurality of notches, are provided.

7. The attachment structure for a connecting member for seat and an attachment member according to claim 1, wherein the contact portion is tapered to have a height gradually decreasing toward a distal end.

8. A seat structure comprising:
a connecting member for seat in a form of a pipe extending between right-and-left cushion frames; and
an attachment member, wherein
the connecting member for seat is formed in a pipe,
the attachment member includes an engaging part which engages with an end portion of the connecting member for seat, the engaging part includes
a plurality of contact portions circumferentially arrayed with a predetermined interval to make contact with an inner circumferential surface of the connecting member for seat, and
a plurality of non-contact portions, each provided between the contact portions, making no contact with the inner circumferential surface of the connecting member for seat, and
an adhesive is applied to the non-contact portion when the engaging part of the attachment member engages with the end portion of the connecting member for seat.
